(19) United States
(12) Patent Application Publication
(10) Pub. No.: US 2019/0173085 A1
(43) Pub. Date: Jun. 6, 2019

(54) NONAQUEOUS ELECTROLYTE SECONDARY BATTERY

(71) Applicant: Panasonic Intellectual Property Management Co., Ltd., Osaka-shi, Osaka (JP)

(72) Inventors: Masanori Sugimori, Hyogo (JP); Natsumi Goto, Hyogo (JP); Kouhei Tuduki, Hyogo (JP); Katsunori Yanagida, Hyogo (JP)

(73) Assignee: Panasonic Intellectual Property Management Co., Ltd., Osaka-shi, Osaka (JP)

(21) Appl. No.: 15/772,701

(22) PCT Filed: Nov. 21, 2016
(86) PCT No.: PCT/JP2016/004933

§ 371 Date: May 1, 2018

(30) Foreign Application Priority Data
Nov. 30, 2015 (JP) 2015-233494

(51) Int. Cl. H01M 4/525; H01M 10/0525; H01M 4/485

(52) U.S. Cl. CPC H01M 4/525; H01M 4/485; H01M 10/0525

(57) ABSTRACT

A nonaqueous electrolyte secondary battery according to the present invention includes a positive electrode, a negative electrode, a separator placed between the positive electrode and the negative electrode, and a nonaqueous electrolyte. The positive electrode contains a first lithium transition metal oxide in which Ni accounts for 30 mole percent or more of the total molar amount of metal elements excluding Li; a second lithium transition metal oxide in which Co and Ni account for 60 mole percent or more and 20 mole percent or less, respectively, of the total molar amount of metal elements excluding Li; and tungsten element. The negative electrode contains a lithium-titanium composite oxide.

### TECHNICAL FIELD

The present invention relates to a technique for nonaqueous electrolyte secondary batteries.

### BACKGROUND ART

At present, nonaqueous electrolyte secondary batteries are attracting attention as motor power supplies for electric tools, electric vehicles (EVs), hybrid electric vehicles (HEVs and PHEVs), and the like in addition to consumer applications including mobile data terminals such as mobile phones, notebook personal computers, and smartphones and are expected to be used for wider applications. Such motor power supplies are required to have increased capacity so as to be used for a long time or enhanced power characteristics in the case of repeating large-current charge and discharge in a relatively short time.

A nonaqueous electrolyte secondary battery in which a lithium-titanium composite oxide is used for a negative electrode active material is stable at high potential and therefore is increasingly expected for novel applications.

Using a lithium-titanium composite oxide for a negative electrode active material reduces the irreversible capacity of a negative electrode. Therefore, in the case of combining the negative electrode with a positive electrode in which a lithium transition metal oxide having high Ni content is used for a positive electrode active material, the irreversible capacity of the positive electrode is generally greater than the irreversible capacity of the negative electrode and discharge cut-off is regulated by the positive electrode in the final stage of discharge. In particular, in the case of using a lithium transition metal oxide having a layered structure for a positive electrode active material, when discharge cut-off is regulated by a positive electrode in the final stage of discharge, the positive electrode active material is likely to be over-discharged; hence, the deterioration of the positive electrode active material is caused in charge-discharge cycles in some cases.

Patent Literature 1 discloses that the irreversible capacity of a positive electrode is reduced using a lithium transition metal oxide having low Ni content for positive electrode active material.

Patent Literature 2 discloses that a lithium transition metal oxide having high Ni content and a lithium transition metal oxide having low Ni content are mixed in a positive electrode such that the positive electrode has high irreversible capacity.

### CITATION LIST

### Patent Literature

PTL 1: Japanese Published Unexamined Patent Application No. 2007-66834

PTL 2: Japanese Published Unexamined Patent Application No. 2012-142157

### SUMMARY OF INVENTION

In general, lithium transition metal oxides having low Ni content and high Co content tend to offer lower positive electrode irreversible capacity as compared to lithium transition metal oxides having high Ni content. Therefore, it is conceivable that a negative electrode containing a lithium-titanium composite oxide is combined with a positive electrode containing a lithium transition metal oxide having high Ni content and a lithium transition metal oxide having low Ni content and high Co content such that the irreversible capacity of the positive electrode is lower than the irreversible capacity of the negative electrode, whereby discharge cut-off is regulated by the negative electrode in the final stage of discharge.

However, in the case of combining the negative electrode with the positive electrode, there is a problem in that the IV resistance of a battery, particularly the IV resistance of a battery due to high-temperature storage (for example, 60° C. or higher) increases. As a result, power characteristics of the battery decrease in some cases.

It is an object of the present disclosure to provide a nonaqueous electrolyte secondary battery capable of suppressing the increase of battery IV resistance in a combination of a negative electrode containing a lithium-titanium composite oxide and a positive electrode containing a lithium transition metal oxide having high Ni content and a lithium transition metal oxide having low Ni content (including a Ni content of 0) and high Co content.

An aspect of the present disclosure provides a nonaqueous electrolyte secondary battery including a positive electrode, a negative electrode, a separator placed between the positive electrode and the negative electrode, and a nonaqueous electrolyte. The positive electrode contains a first lithium transition, metal oxide in which Ni accounts for 30 mole percent or more of the total molar amount of metal elements excluding Li; a second lithium transition metal oxide in which Co and Ni account for 60 mole percent or more and 20 mole percent or less, respectively, of the total molar amount of metal elements excluding Li; and tungsten element. The negative electrode contains a lithium-titanium composite oxide.

According to an aspect of the present disclosure, the increase in IV resistance of a battery can be suppressed.

### DESCRIPTION OF EMBODIMENTS

### Underlying Knowledge Forming Basis of the Present Disclosure

Combining a negative electrode containing a lithium-titanium composite oxide with a positive electrode containing a lithium transition metal oxide having high Ni content and a lithium transition metal oxide having low Ni content and high Co content enables discharge cut-off to be regulated by the negative electrode in the final stage of discharge; however, causes a problem that the IV resistance of a battery, particularly the IV resistance of a battery due to high-temperature storage (for example, 60° C. or higher) decreases; and is likely to lead to the reduction of power characteristics of a battery. As a result of intensive investigations, the inventors have found that, in a combination of the negative electrode and the positive electrode, Co dissolved mainly from the lithium transition metal oxide having low Ni content and high Co content by the repetition of charge and discharge precipitates on the negative electrode to cause the increase in resistance of the negative electrode and the increase in IV resistance of a battery. The inventors have conceived inventions of aspects described below on the basis of the above finding.

A nonaqueous electrolyte secondary battery according to an aspect of the present disclosure is a nonaqueous electrolyte secondary battery including a positive electrode, a negative electrode, a separator placed between the positive electrode and the negative electrode, and a nonaqueous electrolyte. The positive electrode contains a first lithium transition metal oxide in which Ni accounts for 30 mole percent or more of the total molar amount of metal elements excluding Li; a second lithium transition metal oxide in which Co and Ni account for 60 mole percent or more and 20 mole percent or less, respectively, of the total molar amount of metal elements excluding Li; and tungsten element. The negative electrode contains a lithium-titanium composite oxide. In accordance with the nonaqueous electrolyte secondary battery according to an aspect of the present disclosure, the increase in IV resistance of a battery, particularly the increase in IV resistance of a battery due to high-temperature storage (for example, 60° C. or higher) can be suppressed.

This mechanism is not sufficiently clear but is probably as described below. It is conceivable that tungsten in the positive electrode is dissolved from the positive electrode together with cobalt and is precipitated on the negative electrode by the charge and discharge of the battery and cobalt and tungsten are co-present on the negative electrode. It is conceivable that the co-presence of cobalt and tungsten on the negative electrode as described above probably increases the reactivity of the negative electrode, which contains the lithium-titanium composite oxide, and a specifically high negative electrode resistance increase-suppressing effect is obtained. As a result, the increase in IV resistance of the battery is probably suppressed, so that the reduction of power characteristics of the battery is suppressed.

In the nonaqueous electrolyte secondary battery according to another aspect of the present disclosure, a portion of tungsten element contained in the positive electrode is present in the form of a solid solution in at least one of the first lithium transition metal oxide and the second lithium transition metal oxide and another portion of tungsten element contained in the positive electrode is present in the form of a tungsten compound attached to the surface of at least one of the first lithium transition metal oxide and the second lithium transition metal oxide. This enables the increase in IV resistance of the battery to be suppressed as compared to the case where the positive electrode is simply made of a lithium transition metal oxide in which tungsten element is present in the form of a solid solution or the case where the positive electrode is simply made of a mixture of a tungsten compound and a lithium transition metal oxide.

In the nonaqueous electrolyte secondary battery according to another aspect of the present disclosure, tungsten element in the tungsten compound attached to the surface of the lithium transition metal oxide accounts for 0.01 mole percent to 3.0 mole percent of the total molar amount of metal elements, excluding Li, in the lithium transition metal oxide. This enables the increase in IV resistance of the battery to be suppressed as compared to the case where tungsten element in the tungsten compound is outside the above range.

In the nonaqueous electrolyte secondary battery according to another aspect of the present disclosure, tungsten element present in the form of a solid solution in the lithium transition metal oxide accounts for 0.01 mole percent to 3.0 mole percent of the total molar amount of metal elements, excluding Li, in the lithium transition metal oxide. This enables the increase in IV resistance of the battery to be suppressed as compared to the case where the tungsten element is outside the above range.

An example of a nonaqueous electrolyte secondary battery according to an aspect of the present disclosure is described below.

The nonaqueous electrolyte secondary battery according to an aspect of the present disclosure includes a positive electrode, a negative electrode, a separator placed between the positive electrode and the negative electrode, and a nonaqueous electrolyte. An example of the structure of the nonaqueous electrolyte secondary battery is a structure in which an electrode assembly formed by winding the positive electrode and the negative electrode with the separator therebetween and the nonaqueous electrolyte are housed in an enclosure. Alternatively, another type of electrode assembly such as a stacked electrode assembly formed by stacking the positive electrode and the negative electrode with the separator therebetween may be used instead of a wound electrode assembly. The nonaqueous electrolyte secondary battery may be of any type including, for example, a cylinder type, a prism type, a coin type, a button type, and a laminate type.

### Negative Electrode

The negative electrode is preferably composed of, for example, a negative electrode current collector made of metal foil or the like and a negative electrode mix layer formed on the negative electrode current collector. The negative electrode current collector used may be foil of a metal stable within the potential range of the negative electrode, a film including a surface layer made of the metal, or the like. The negative electrode mix layer preferably contains a negative electrode active material, a binding agent, a conductive agent, and the like.

The negative electrode active material contains a lithium-titanium composite oxide. The lithium-titanium composite oxide is preferably lithium titanate in terms of power, safety during charge and discharge, and the like. Lithium titanate is preferably lithium titanate having a spinel-type crystal structure. As the lithium titanate having the spinel-type crystal structure, Li₄₊ₓTi₅O₁₂ (0≤X≤3) is exemplified. The lithium titanate having the spinel-type crystal structure has little expansion and contraction associated with the intercalation and deintercalation of lithium, is unlikely to be deteriorated, and therefore is useful in obtaining batteries with excellent durability. Having a spinel structure can be readily confirmed by X-ray diffraction or the like.

The specific surface area of the lithium-titanium composite oxide is, for example, 2 m²/g or more, preferably 3 m²/g or more, and more preferably 4 m²/g or more as measured by the BET method. When the specific surface area thereof is less than 2 m²/g, input-output characteristics are low in some cases. When the specific surface area of the lithium-titanium composite oxide is too large, the crystallinity thereof is low and the durability is impaired in some cases. Therefore, the specific surface area thereof is preferably 8 m²/g or less.

A portion of Ti element in the lithium-titanium composite oxide may be substituted with one or more elements different from Ti. Substituting a portion of Ti element in the lithium-titanium composite oxide with one or more elements different from Ti allows a negative electrode-regulated non-aqueous electrolyte secondary battery having as irreversible capacity ratio larger than that of the lithium-titanium composite oxide to be readily obtained. Examples of an element different from Ti include manganese (Mn), iron (Fe), vanadium (V), boron (B), and niobium (Nb).

The average primary particle size of the lithium-titanium composite oxide is preferably, for example, 0.1 μm to 10 μm and more preferably 0.3 μm to 1.0 μm. When the average primary particle size thereof is less than 0.1 μm, the number of interfaces between primary particles is too large and therefore particles are likely to be cracked due to expansion and contraction in charge-discharge cycles in some cases. However, when the average primary particle size thereof is more than 10 μm, the number of the interfaces between the primary particles is too small and therefore particularly power characteristics are low in some cases.

The negative electrode current collector used is preferably a conductive thin film, metal foil stable within the potential range of the negative electrode, alloy foil stable within the potential range of the negative electrode, a film including a metal surface layer, or the like. In the case of using the lithium-titanium composite oxide, aluminium foil is preferably used and, for example, copper foil, nickel foil, stainless steel foil, or the like may be used.

Examples of the binding agent include a fluorinated resin, PAN, a polyimide resin, an acrylic resin, and a polyolefin resin. In the case of preparing negative electrode mix slurry using an organic solvent, polyvinylidene fluoride (PVdF) or the like is preferably used.

### Positive Electrode

The positive electrode is composed of, for example, a positive electrode current collector made of metal foil or the like and a positive electrode mix layer formed on the positive electrode current collector. The positive electrode current collector used may be foil of a metal, such as aluminium, stable within the potential range of the positive electrode, a film including a surface layer made of the metal, or the like. The positive electrode mix layer contains a positive electrode active material and preferably further contains a binding agent and a conductive agent.

The positive electrode active material contains a first lithium transition metal oxide in which Ni accounts for 30 mole percent or more of the total molar amount of metal elements excluding Li; a second lithium transition metal oxide in which Co and Ni account for 60 mole percent or more and 20 mole percent or less, respectively, of the total molar amount of metal elements excluding Li; and tungsten element.

In usual, in the case of using a positive electrode containing the first lithium transition metal oxide and the second lithium transition metal oxide, Co is dissolved mainly from the second lithium transition metal oxide to precipitate on a negative electrode in association with the charge and discharge of a battery, thereby increasing the resistance of the battery.

However, in accordance with the positive electrode according to the present disclosure, tungsten in the positive electrode and cobalt mainly in the second lithium transition metal oxide are precipitated in association with the charge and discharge of the battery and are co-present on the negative electrode. This increases the reactivity of the negative electrode, which contains the lithium-titanium composite oxide; hence, it is conceivable that a specifically high negative electrode resistance increase-suppressing effect is obtained. As a result, the increase in IV resistance of the battery can be probably suppressed, leading to the suppression of the reduction in power characteristic of the battery.

Tungsten element may be present in any form in the positive electrode active material. Tungsten element may be present in the form of, for example, solid solution in the first lithium transition metal oxide and/or the second lithium transition metal oxide (that is, in the form of a first lithium transition metal oxide containing tungsten element and/or a lithium transition metal oxide containing tungsten element), may be present in the form of a tungsten compound attached to the surfaces of particles of the first lithium transition metal oxide and/or the second lithium transition metal oxide (in a non-solid solution state that no solid solution is present in the first or second lithium transition metal oxide), or may foe present in both forms. In terms of suppressing the reduction of power characteristics of the battery or the like, it is preferable that a portion of tungsten element contained in the positive electrode is present in the form of a solid solution in at least one of the first lithium transition metal oxide and the second lithium transition metal oxide and another portion of tungsten element contained in the positive electrode is present in the form of a tungsten compound attached to the surface of at least one of the first lithium transition metal oxide and the second lithium transition metal oxide.

Tungsten element in a tungsten compound attached to the surfaces of particles of the lithium transition metal oxide preferably accounts for 0.01 mole percent to 3.0 mole percent of the total molar amount of transition metals, excluding lithium, in the lithium transition metal oxide; more preferably 0.03 mole percent to 2.0 mole percent; and particularly preferably 0.05 mole percent to 1.0 mole percent. When tungsten element in the tungsten compound accounts for less than 0.01 mole percent, the amount of tungsten with respect to the amount of cobalt precipitated on the negative electrode is insufficient and the IV resistance of the battery is increased in some cases as compared to the case where the above range is satisfied. When tungsten element in the tungsten compound accounts for more than 3.0 mole percent, the amount of tungsten precipitated on the negative electrode is too large, the ionic conductivity of a coating is low, and the capacity of the battery is low in some cases as compared to the case where the above range is satisfied.

The tungsten compound is preferably tungsten oxide. In this case, tungsten oxide is preferably attached to the surface of the lithium transition metal oxide in a dotted pattern and is more preferably uniformly attached to the surface thereof in a dotted pattern. Examples of tungsten oxide include WO₃, WO₂, and W₂O₃. Among these oxides, WO₃ is more preferable in that the valence is large and a coating with a high resistance increase-suppressing effect is likely to be formed in a small amount in co-presence with cobalt.

Tungsten element present in the form of a solid solution in the lithium transition metal oxide preferably accounts for 0.01 mole percent to 3.0 mole percent of the total molar amount of the transition metals, excluding lithium, in the lithium transition metal oxide; more preferably 0.03 mole percent to 2.0 mole percent; and particularly preferably 0.05 mole percent to 1.0 mole percent. When tungsten element present in the form of a solid solution accounts for less than 0.01 mole percent, the amount of tungsten with respect to the amount of cobalt precipitated on the negative electrode is insufficient and the IV resistance of the battery is increased in some cases as compared to the case where the above range is satisfied. When tungsten element present in the form of a solid solution accounts for more than 3.0 mole percent, the amount of tungsten contained in a coating is too large, the ionic conductivity of the coating is low, and the capacity of the battery is low in some cases as compared to the case where the above range is satisfied. The expression “tungsten is present in the form of a solid solution in the lithium transition metal oxide” means a state in which a portion of a metal element, such as nickel or cobalt, in the lithium transition metal oxide active material is substituted with tungsten element and tungsten element is present in the inside (crystal) of the lithium transition metal oxide.

For the presence of tungsten in the form of a solid solution in the lithium transition metal oxide and the measurement of the amount of a solid solution, methods below are cited. The presence of tungsten in the form of a solid solution in the lithium transition metal oxide can be confirmed and the amount of the solid solution can be measured in such a manner that, for example, a powder of the lithium transition metal oxide is cut or is surface-ground and tungsten is qualitatively and quantitatively analyzed by Auger electron spectroscopy (AES), secondary ion mass spectroscopy (SIMS), transmission electron microscope (TEM)-energy dispersive X-ray spectroscopy (EDX), electron probe microanalyser (EPMA), or the like.

The total amount of tungsten present in the form of a solid solution in the lithium transition metal oxide and tungsten attached to the lithium transition metal oxide is determined in such a manner that, for example, a powder of the lithium transition metal, oxide is washed with an acid solution for 20 minutes and the amount of tungsten dissolved in the acid solution is measured by inductively coupled plasma ionization (ICP) emission spectrometry. From measurement results of the amount of the solid solution and the total amount, the amount of tungsten, not in the form of a solid solution, attached to the lithium transition metal oxide can be calculated.

The first lithium transition metal oxide is not particularly limited and may be a lithium transition metal oxide in which Ni accounts for 30 mole percent or more of the total molar amount of metal elements excluding Li. The first lithium transition metal oxide is represented by, for example, the general formula LiMeₓO₂ (Me is one or more types of metal elements, in which Ni accounts for 30% or more).

The first lithium transition metal oxide may contain, for example, at least one of other transition metals such as manganese (Mn) and cobalt (Co) in addition to nickel (Ni). The first lithium transition metal oxide may contain, for example, a non-transition metal such as aluminium (Al) or magnesium (Mg). Examples of the first lithium transition metal oxide include Ni—Co—Mn-based, Ni—Co—Al-based, and Ni—Mn—Al-based lithium transition metal oxides. These oxides used alone or in combination.

Among the above oxides, a Ni—Co—Mn-based lithium transition metal oxide is preferable in terms of power characteristics, regeneration characteristics, and the like. An example of the Ni—Co—Mn-based lithium transition metal oxide may be one in which the molar ratio of Ni to Co to Mn is 1:1:1, 5:2:3, 4:4:2, 5:3:2, 6:2:2, 55:25:20, 7:2:1, 7:1:2, or 8:1:1.

An example of the Ni—Co—Al-based lithium transition metal oxide may be one in which the molar ratio of Ni to Co to M is 82:15:3, 82:12:6, 80:10:10, 80:15:5, 37:9:4, 90:5:5, or 95:3:2.

The second lithium transition metal oxide is not particularly limited and may be a lithium transition metal oxide in which Co and Ni account for 60 mole percent or more and 20 mole percent or less, respectively, of the total molar amount of metal elements excluding Li. The second lithium transition metal oxide is represented by, for example, the general formula LiMe_{y}O₂ (Me is one or more types of metal elements, in which Co accounts for 60% or more and Ni accounts for 20% or less).

The second lithium transition metal oxide may contain, for example, at least one of transition metals such as nickel (Ni) and manganese (Mn) in addition to cobalt (Co). The second lithium transition metal oxide may contain, for example, a non-transition metal such as aluminium (Al) or magnesium (Mg). Examples of the second lithium transition metal oxide include lithium cobaltate-based and Ni—Co—Mn-based lithium transition metal oxides.

The first and second lithium transition metal oxides are not limited to the above-exemplified elements and may contain an additive element. Examples of the additive element include boron, magnesium, aluminium, titanium, vanadium, iron, copper, zinc, niobium, zirconium, tin, tantalum, sodium, potassium, barium, strontium, and calcium.

The average particle size of the first and second lithium transition metal oxides is preferably, for example, 2 μm to 30 μm. Particles of the first and second lithium transition metal oxides may be secondary particles composed of bonded primary particles with a size of, for example, 100 nm to 10 μm. The average particle size thereof can be measured with, for example, a particle size distribution analyzer (manufactured by HORIBA).

The average particle size of the tungsten compound attached to the surfaces of the first and second lithium transition metal oxide particles is preferably less than the average particle size of the first and second lithium transition metal oxides and is particularly preferably less than one-fourth thereof. When the tungsten compound is greater than the first and second lithium transition metal oxides, the contact area between the tungsten compound and the lithium transition metal oxide is small and the effect of suppressing the increase in resistance of the negative electrode is not sufficiently exhibited in some cases.

An example of a method for forming a solid solution of tungsten in the lithium transition metal oxide and an example of a method for attaching the tungsten compound to the surface of the lithium transition metal oxide are described.

The method for forming the tungsten solid solution in the lithium transition metal oxide is a method in which raw materials including a transition metal oxide containing nickel or cobalt, a lithium compound such as lithium hydroxide or lithium carbonate, and a tungsten compound such as tungsten oxide are mixed together, followed by firing at a predetermined temperature, or the like. The firing temperature is preferably 650° C. to 1,000° C. and particularly preferably 700° C. to 950° C. When, the firing temperature is lower than 650° C., the decomposition of the lithium compound, such as lithium hydroxide, is insufficient and reaction is unlikely to proceed. When the firing temperature is 1,000° C. or higher, cation mixing is active and inhibits the diffusion of Li⁺; hence, the specific capacity is low or load characteristics are low in some cases.

The method for attaching tungsten oxide to the surface of the lithium transition metal oxide is a method in which tungsten oxide is mechanically mixed with the first lithium transition metal oxide and/or the second lithium transition metal oxide in advance and is thereby attached thereto, a method in which tungsten oxide is added in a step of kneading the conductive agent and the binding agent, or the like.

The lithium transition metal oxide may contain another positive electrode active material in addition to the above-mentioned first and second lithium transition metal oxides. The other positive electrode active material is not particularly limited and may be, for example, a compound capable of reversibly intercalating and deintercalating lithium ions. The other positive electrode active material used may be, for example, a spinel-structured material such as a lithium manganese oxide, an olivine-structured material, or the like.

The positive electrode preferably contains a phosphate compound. When the phosphate compound is contained therein, a coating made of a decomposition product of an electrolyte solution is formed on the positive electrode active material during charge and discharge in the initial usage of the battery, whereby the corrosion of the positive electrode active material by HF and the dissolution of metal are inhibited. This suppresses the further reaction of a corroded portion of the positive electrode active material with the electrolyte solution to suppress the generation of an H₂ gas, a CO gas, a CO₂ gas, and the like. The phosphate compound in the positive electrode is preferably lithium phosphate. The lithium phosphate is preferably Li₃PO₄.

The binding agent is a fluoropolymer, a rubber polymer, or the like. Examples of the fluoropolymer include polytetrafluoroethylene (PTFE), polyvinylidene fluoride (PVdF), and modifications of these polymers. Examples of the rubber polymer include ethylene-propylene-isoprene copolymers and ethylene-propylene-butadiene copolymers. These polymers and copolymers may be used alone or in combination. The binding agent may be used in combination with a thickening agent such as carboxymethylcellulose (CMC) or polyethylene oxide (PEO).

Examples of the conductive agent include carbon materials such as carbon black, acetylene black, Ketjenblack, graphite, vapor-grown carbon (VGCF), carbon nanotubes, and carbon nanofibers. These materials may be used alone or in combination.

### Separator

Examples of the separator include separators made of polypropylene, separators made of polyethylene, polypropylene-polyethylene multilayer separators, separators surface-coated with resin such as an aramid resin, and separators containing cellulose. The separator used is preferably a polypropylene-containing separator.

A layer made of an inorganic filler may be placed at the interface between the positive electrode and the separator or the interface between the negative electrode and the separator. Examples of the filler include oxides containing one or more of titanium, aluminium, silicon, magnesium, and the like; phosphate compounds containing one or more of titanium, aluminium, silicon, magnesium, and the like; and those surface-treated with a hydroxide or the like.

### Nonaqueous Electrolyte

Examples of a solvent for the nonaqueous electrolyte include cyclic carbonates such as ethylene carbonate, propylene carbonate, butylene carbonate, and vinylene carbonate and linear carbonates such as dimethyl carbonate, ethyl methyl carbonate, and diethyl carbonate. The solvent may be those obtained by partially or entirely fluorinating hydrogen of these carbonates. In particular, in order to suppress the generation of gas or the like, a cyclic carbonate is preferably contained. When the cyclic carbonate is contained, a good coating is formed on the surface of the lithium transition metal oxide. Therefore, the corrosion of the positive electrode active material by HF and the dissolution of metal are suppressed and the generation of gas in charge-discharge cycles is suppressed.

The cyclic carbonate used is preferably propylene carbonate in terms of the reduction in generation of gas, excellent low-temperature input-output characteristics, and the like.

A solvent mixture of the cyclic carbonate and a linear carbonate is preferably used in terms of having low viscosity, a low melting point, and high lithium ion conductivity. Furthermore, the volume ratio of the cyclic carbonate to the linear carbonate in the solvent mixture is preferably regulated in the range of 2:8 to 5:5.

The nonaqueous electrolyte may contain an ester-containing compound such as methyl acetate, ethyl acetate, propyl acetate, methyl propionate, ethyl propionate, or γ-butyrolactone. The nonaqueous electrolyte may contain a sulfo group-containing compound such as propanesultone; an ether-containing compound such as 1,2-dimethoxyethane, 1,2-diethoxyethane, tetrahydrofuran, 1,3-dioxane, 1,4-dioxane, or 2-methyltetrahydrofuran; or the like. The nonaqueous electrolyte may contain a nitrile-containing compound such as butyronitrile, valeronitrile, n-heptanenitrile, succinonitrile, glutaronitrile, adiponitrile, pimelonitrile, 1,2,3-propanetricarbonitrile, or 1,3,5-pentanetricarbonitrile; an amide-containing compound such as dimethylformamide; or the like. Solvents obtained by partially substituting hydrogen atoms H of these compounds with fluorine atoms F can be used.

Examples of a solute for the nonaqueous electrolyte include LiPF₆, LiBF₄, LiCF₃SO₃, LiN(FSO₂)₂, LiN (CF₃SO₂)₂, LiN(C₂F₅O₂)₂, LiN (CF₃SO₂) (C₄F₉SO₂), LiC (C₂F₅SO₂) and LiAsF₆. Furthermore, one obtained by adding a lithium salt (a lithium salt (for example, LiClO₄, LiPO₂F₂, or the like) containing one or more of P, B, O, S, N, and Cl) other than a fluorine-containing lithium salt to the fluorine-containing lithium salt may be used. In particular, using an electrolyte salt containing a F element in its structural formula suppresses the corrosion of the positive electrode active material by HF and the dissolution of metal.

### EXAMPLES

The present invention is further described below in detail with reference to examples. The present invention is not limited to the examples.

### Example 1

### Preparation of Positive Electrode Active Material

A hydroxide, represented by [Ni_{0.35}Co_{0.35}Mn_{0.30}](OH)₂, obtained by coprecipitation was fired at 500° C., whereby a nickel-cobalt-manganese composite oxide was obtained. Next, lithium carbonate and the nickel-cobalt-manganese composite oxide obtained as described above were mixed together in an Ishikawa-type Raikai mortar such that the molar ratio of lithium to the total amount of nickel, cobalt, and manganese was 1.20:1. Thereafter, the mixture was heat-treated at 900° C. for 20 hours in an air atmosphere, followed by crushing, whereby a first lithium transition metal oxide represented by Li_{1.2}[Ni_{0.35}Co_{0.35}Mn_{0.30}]O₂ was obtained.

Next, a hydroxide, represented by [Ni_{0.2}Co_{0.6}Mn_{0.2}](OH)₂, obtained by coprecipitation was fired at 500° C., whereby a nickel-cobalt-manganese composite oxide was obtained. Lithium carbonate, the nickel-cobalt-manganese composite oxide obtained as described above, and tungsten oxide (WO₃) were mixed together in an Ishikawa-type Raikai mortar such that the molar ratio of lithium to the total amount of nickel, cobalt, and manganese to tungsten was 1.20:1:0.005. Thereafter, the mixture was heat-treated at 900° C. for 20 hours in an air atmosphere, followed by crushing, whereby a second lithium transition metal oxide, represented by Li_{1.2}[Ni_{0.2}Co_{0.6}Mn_{0.2}]O₂, containing a solid solution of tungsten was obtained. An obtained powder was observed with a scanning electron microscope (SEM), whereby it was confirmed that no unreacted tungsten oxide (WO₃) remained.

The Li_{1.2}[Ni_{0.35}Co_{0.35}Mn0.30]O₂ and the Li_{1.2}[Ni_{0.2}Co_{0.6}Mn_{0.2}]O₂ containing the tungsten solid solution were mixed together using HIVIS DISPER MIX (manufactured by PRIMIX Corporation), whereby a positive electrode active material was prepared. In the obtained positive electrode active material, the molar ratio of the total amount of nickel, cobalt, and manganese in the first lithium transition metal oxide to the total amount of nickel, cobalt, and manganese in the second lithium transition metal oxide to tungsten present in the form of a solid solution in the second lithium transition metal oxide was 0.800:0.200:0.001. This was referred to as Positive Electrode Active Material A1.

### Preparation of Positive Electrode Plate

Positive Electrode Active Material A1, acetylene black serving as a conductive agent, and polyvinylidene fluoride serving as a binding agent were weighed such that the mass ratio of Positive Electrode Active Material A1 to acetylene black to polyvinylidene fluoride was 91:7:2, followed by adding N-methyl-2-pyrrolidone serving as a dispersion medium. These materials were kneaded, whereby positive electrode mix slurry was prepared. Next, the positive electrode mix slurry was applied to both surfaces of a positive electrode current collector made of aluminium foil, this was dried and was then rolled using a rolling roller, and a current-collecting tab made of aluminium was attached thereto, whereby a positive electrode plate including the positive electrode current collector and positive electrode mix layers formed on both surfaces of the positive electrode current collector was prepared.

### Preparation of Lithium-Titanium Composite Oxide

Source powders of LiOH.H₂O and TiO₂, which were commercially available reagents, were weighed such that the Li/Ti molar mixing ratio was slightly higher in Li than the stoichiometric ratio, followed by mixing these powders in a mortar. The raw material TiO₂ used was one having an anatase crystal, structure. The mixed source powders were put in a crucible made of Al₂O₃ and were heat-treated at 850° C. for 12 hours in an air atmosphere, whereby Li₄Ti₅O₁₂ was obtained.

The heat-treated material was taken out of the crucible and was then crushed in a mortar, whereby a coarse powder of Li₄Ti₅O₁₂ was obtained. The obtained Li₄Ti₅O₁₂ coarse powder was measured with a powder X-ray diffractometer (manufactured by Rigaku Corporation), whereby a diffraction pattern of a single phase having a spinel structure with a space group assigned to Fd-3m was obtained.

The obtained Li₄Ti₅O₁₂ coarse powder was jet-milled and was then classified. An obtained powder was observed with a scanning electron microscope (SEM), whereby it was confirmed that the coarse powder was milled into single particles with a size of about 0.7 μm. The BET specific surface area of the classified Li₄Ti₅O₁₂ powder was measured using a specific surface area analyzer (TriStar II 3020, manufactured by Shimadzu Corporation) and was found to be 6.8 m²/g.

### Preparation of Negative Electrode Plate

Li₄Ti₅O₁₂ obtained by the above method, carbon black serving as a conductive agent, polyvinylidene fluoride serving as a binder, and fluorinated graphite serving as an additive were weighed such that the mass ratio of Li₄Ti₅O₁₂ to acetylene black to PVdF was 100:7:3, followed by adding N-methyl-2-pyrrolidone serving as a dispersion medium. These materials were kneaded, whereby negative electrode mix slurry was prepared. Next, the negative electrode mix slurry was applied to both surfaces of a negative electrode current collector made of aluminium foil, this was dried and was then rolled using a rolling roller, and a current-collecting tab made of aluminium was attached thereto, whereby a negative electrode plate including the negative electrode current collector and negative electrode mix layers formed on both surfaces of the negative electrode current collector was prepared.

### Preparation of Nonaqueous Electrolyte

LiPF₆ serving as a solute was dissolved in a solvent mixture of PC (propylene carbonate), EMC (ethyl methyl carbonate), and DMC (dimethyl carbonate) mixed at a volume ratio of 25:35:40 at a rate of 1.2 moles per liter.

### Preparation of Battery

The positive electrode and negative electrode obtained in this way were wound with a separator composed of three layers of PP (polypropylene)/PE (polyethylene)/PP therebetween so as to face each other, whereby a roll was prepared. After the roll was vacuum-dried at 105° C. for 150 minutes, the roll was sealed in an enclosure composed of an aluminium laminate sheet together with the nonaqueous electrolyte in a glove box under an argon atmosphere, whereby a battery was prepared. The design capacity of the battery was 11 mAh.

### Example 2

A hydroxide, represented by [Ni_{0.35}Co_{0.35}Mn_{0.03}](OH)₂, obtained by coprecipitation was fired at 500° C., whereby a nickel-cobalt-manganese composite oxide was obtained. Next, lithium carbonate, the nickel-cobalt-manganese composite oxide obtained as described above, and tungsten oxide (WO₃) were mixed together in an Ishikawa-type Raikai mortar such that the molar ratio of lithium to the total amount of nickel, cobalt, and manganese to tungsten was 1.20:1:0.005. Thereafter, the mixture was heat-treated at 900° C. for 20 hours in an air atmosphere, followed by crushing, whereby a first lithium transition metal oxide, represented by Li_{1.2}[Ni_{0.35}Co_{0.35}Mn_{0.30}]O₂, containing a solid solution of tungsten was obtained. An obtained powder was observed with a scanning electron microscope (SEM), whereby it was confirmed that no unreacted tungsten oxide (WO₃) remained.

Next, a hydroxide, represented by [Ni_{0.2}Co_{0.6}Mn_{0.2}](OH)₂, obtained by coprecipitation was fired at 500° C., whereby a nickel-cobalt-manganese composite oxide was obtained. Lithium carbonate and the nickel-cobalt-manganese composite oxide obtained as described above were mixed together in an Ishikawa-type Raikai mortar such that the molar ratio of lithium to the total amount of nickel, cobalt, and manganese was 1.20:1. Thereafter, the mixture was heat-treated at 900° C. for 20 hours in an air atmosphere, followed by crushing, whereby a second lithium transition metal oxide represented by Li_{1.2}[Ni_{0.2}Co_{0.6}Mn_{0.2}]O₂ was obtained.

The Li_{1.2}[Ni_{0.35}Co_{0.35}Mn_{0.30}]O₂ containing the tungsten solid solution and the Li_{1.2}[Ni_{0.2}Co_{0.6}Mn_{0.2}]O₂ were mixed together using HIVIS DISPER MIX (manufactured by PRIMIX Corporation), whereby a positive electrode active material was prepared. In the obtained positive electrode active material, the molar ratio of the total amount of nickel, cobalt, and manganese in the first lithium transition metal oxide to the total amount of nickel, cobalt, and manganese in the second lithium transition metal oxide to tungsten present in the form of a solid solution in the first lithium transition metal oxide was 0.800:0.200:0.004. This was referred to as Positive Electrode Active Material A2.

In Example 2, a battery was prepared under substantially the same conditions as those used in Example 1 except that Positive Electrode Active Material A2 was used.

### Example 3

The Li_{1.2}[Ni_{0.35}Co_{0.35}Mn_{0.30}]O₂ containing the tungsten solid solution, the Li_{1.2}[Ni_{0.2}Co_{0.6}Mn_{0.2}]O₂, and tungsten oxide (WO₃) were mixed together using HIVIS DISPER MIX (manufactured by PRIMIX Corporation), whereby a positive electrode active material was prepared. In this operation, mixing was performed such that the molar ratio of the total amount of nickel, cobalt, and manganese in the Li_{1.2}[Ni_{0.35}Co_{0.35}Mn_{0.30}]O₂ and the Li_{1.2}[Ni_{0.2}Co_{0.6}Mn_{0.2}]O₂ to tungsten in tungsten oxide (WO₃) was 0.996:0.004. In the obtained positive electrode active material, the molar ratio of the total amount of nickel, cobalt, and manganese in the first lithium transition metal oxide to the total amount of nickel, cobalt, and manganese in the second lithium transition metal oxide to tungsten contained in the form of tungsten oxide was 0.796:0.200:0.004. This was referred to as Positive Electrode Active Material A3. Observing a prepared positive electrode plate with a scanning electron microscope (SEM) showed that tungsten oxide particles with an average size of 150 nm were attached to the surfaces of particles of the lithium transition metal oxides.

In Example 3, a battery was prepared under substantially the same conditions as those used in Example 1 except that Positive Electrode Active Material A3 was used.

### Example 4

The Li_{1.2}[Ni_{0.35}Co_{0.35}Mn_{0.30}]O₂, the Li_{1.2}[Ni_{0.2}Co_{0.6}Mn_{0.2}]O₂ containing the tungsten solid solution, and tungsten oxide (WO₃) were mixed together using HIVIS DISPER MIX (manufactured by PRIMIX Corporation), whereby a positive electrode active material was prepared. In this operation, mixing was performed such that the molar ratio of the total amount of nickel, cobalt, and manganese in the Li_{1.2}[Ni_{0.35}Co_{0.35}Mn_{0.30}]O₂ and the Li_{1.2}[Ni_{0.2}Co_{0.6}Mn_{0.2}]O₂ to tungsten in tungsten oxide (WO₃) was 0.9955:0.0045. In the obtained positive electrode active material, the molar ratio of the total amount of nickel, cobalt, and manganese in the first lithium transition metal oxide to the total amount of nickel, cobalt, and manganese in the second lithium transition metal oxide to tungsten contained in the form of tungsten oxide was 0.8555:0.100:0.0045. This was referred to as Positive Electrode Active Material A4.

In Example 4, a battery was prepared under substantially the same conditions as those used in Example 1 except that Positive Electrode Active Material A4 was used.

### Example 5

The Li_{1.2}[Ni_{0.35}Co_{0.35}Mn_{0.30}]O₂, the Li_{1.2}[Ni_{0.2}Co_{0.6}Mn_{0.2}]O₂ containing the tungsten solid solution, and tungsten oxide (WO₃) were mixed together using HIVIS DISPER MIX (manufactured by PRIMIX Corporation), whereby a positive electrode active material was prepared. In this operation, mixing was performed such that the molar ratio of the total amount of nickel, cobalt, and manganese in the Li_{1.2}[Ni_{0.35}Co_{0.35}Mn_{0.30}]O₂ and the Li_{1.2}[Ni_{0.2}Co_{0.6}Mn_{0.2}]O₂ to tungsten in tungsten oxide (WO₃) was 0.996:0.004. In the obtained positive electrode active material, the molar ratio of the total amount of nickel, cobalt, and manganese in the first lithium transition metal oxide to the total amount of nickel, cobalt, and manganese in the second lithium transition metal oxide to tungsten contained in the form of tungsten oxide was 0.796:0.200:0.004. This was referred to as Positive Electrode Active Material A5.

In Example 5, a battery was prepared under substantially the same conditions as those used in Example 1 except that Positive Electrode Active Material A5 was used.

### Example 6

The Li_{1.2}[Ni_{0.35}Co_{0.35}Mn_{0.30}]O₂, the Li_{1.2}[Ni_{0.2}Co_{0.6}Mn_{0.2}]O₂ containing the tungsten solid solution, and tungsten oxide (WO₃) were mixed together using HIVIS DISPER MIX (manufactured by PRIMIX Corporation), whereby a positive electrode active material was prepared. In this operation, mixing was performed such that the molar ratio of the total amount of nickel, cobalt, and manganese in the Li_{1.2}[Ni_{0.35}Co_{0.35}Mn_{0.30}]O₂ and the Li_{1.2}[Ni_{0.2}Co_{0.6}Mn_{0.2}]O₂ to tungsten in tungsten oxide (WO₃) was 0.9965:0.035. In the obtained positive electrode active material, the molar ratio of the total amount of nickel, cobalt, and manganese in the first lithium transition metal oxide to the total amount of nickel, cobalt, and manganese in the second lithium transition metal oxide to tungsten contained in the form of tungsten oxide was 0.6965:0.300:0.0035. This was referred to as Positive Electrode Active Material A6.

In Example 6, a battery was prepared under substantially the same conditions as those used in Example 1 except that Positive Electrode Active Material A6 was used.

### Example 7

The Li_{1.2}[Ni_{0.35}Co_{0.35}Mn_{0.30}]O₂, the Li_{1.2}[Ni_{0.2}Co_{0.6}Mn_{0.2}]O₂ containing the tungsten solid solution, and tungsten oxide (WO₃) were mixed together using HIVIS DISPER MIX (manufactured by PRIMIX Corporation), whereby a positive electrode active material was prepared. In this operation, mixing was performed such that the molar ratio of the total amount of nickel, cobalt, and manganese in the Li_{1.2}[Ni_{0.35}Co_{0.35}Mn_{0.30}]O₂ and the Li_{1.2}[Ni_{0.2}Co_{0.6}Mn_{0.2}]O₂ to tungsten in tungsten oxide (WO₃) was 0.997:0.003. In the obtained positive electrode active material, the molar ratio of the total amount of nickel, cobalt, and manganese in the first lithium transition metal oxide to the total amount of nickel, cobalt, and manganese in the second lithium transition metal oxide to tungsten contained in the form of tungsten oxide was 0.597:0.400:0.003. This was referred to as Positive Electrode Active Material A7.

In Example 7, a battery was prepared under substantially the same conditions as those used in Example 1 except that Positive Electrode Active Material A7 was used.

### Comparative Example 1

In Comparative Example 1, a battery was prepared under substantially the same conditions as those used in Example 1 except that the Li_{1.2}[Ni_{0.35}Co_{0.35}Mn_{0.30}]O₂ was used as Positive Electrode Active Material B1.

### Comparative Example 2

A hydroxide, represented by [Ni_{0.2}Co_{0.06}Mn_{0.2}] (OH)₂, obtained by coprecipitation was fired at 500° C., whereby a nickel-cobalt-manganese composite oxide was obtained. Next, lithium carbonate and the nickel-cobalt-manganese composite oxide obtained as described above were mixed together in an Ishikawa-type Raikai mortar such that the molar ratio of lithium to the total amount of nickel, cobalt, and manganese was 1.20:1. Thereafter, the mixture was heat-treated at 900° C. for 20 hours in an air atmosphere, followed by crushing, whereby a lithium transition metal oxide represented by Li_{1.2}[Ni_{0.2}Co_{0.6}Mn_{0.2}]O₂ was obtained.

The Li_{1.2}[Ni_{0.35}Co_{0.35}Mn_{0.30}]O₂ and the Li_{1.1}[Ni_{0.2}Co_{0.6}Mn_{0.2}]O₂ were mixed together using HIVIS DISPER MIX (manufactured by PRIMIX Corporation), whereby a positive electrode active material was prepared. In the obtained positive electrode active material, the molar ratio of the total amount of nickel, cobalt, and manganese in the Li_{1.2}[Ni_{0.35}Co_{0.35}Mn_{0.30}]O₂ to the total amount of nickel, cobalt, and manganese in the Li_{1.2}[N_{0.2}Co_{0.6}Mn_{0.2}]O₂ was 0.800:0.200. This was referred to as Positive Electrode Active Material B2.

In Comparative Example 2, a battery was prepared under substantially the same conditions as those used in Example 1 except that Positive Electrode Active Material B2 was used.

### Comparative Example 3

The Li_{1.2}[Ni_{0.35}Co_{0.35}Mn_{0.30}]O₂ and tungsten oxide (WO₃) were mixed together using HIVIS DISPER MIX (manufactured by PRIMIX Corporation), whereby a positive electrode active material was prepared. In the obtained positive electrode active material, the molar ratio of the total amount of nickel, cobalt, and manganese in the Li_{1.2}[Ni_{0.35}Co_{0.35}Mn_{0.30}]O₂ to tungsten contained in the form of tungsten oxide was 0.995:0.005. This was referred to as Positive Electrode Active Material B3.

In Comparative Example 3, a battery was prepared under substantially the same conditions as those used in Example 1 except that Positive Electrode Active Material B3 was used.

The battery of each of Examples 1 to 7 and Comparative Examples 1 to 3 was charged and discharged for five cycles under conditions below.

(Initial Charge-Discharge Conditions)

Charge-discharge conditions in the first cycle: Constant-current charge was performed at a charge current of 2.2 mA under 25° C. temperature conditions until the voltage of the battery reached 2.65 V, followed by performing constant-current discharge at a discharge current of 2.2 mA until the battery voltage reached 1.5 V.

Charge-discharge conditions in the second to fifth cycles: Constant-current charge was performed at a charge current of 11 mA under 25° C. temperature conditions until the battery voltage reached 2.65 V and constant-voltage charge was further performed at a constant voltage of 2.65 V until the current reached 0.4 mA. Next, the battery was discharged to 1.5 V at a discharge current of 11 mA in a constant current mode. Incidentally, the interval between the charge and the discharge was 10 minutes.

(High-Temperature Storage Test)

After the above charge and discharge for five cycles, the battery was charged to 2.65 V under 25° C. temperature conditions in a constant current mode, was left stationary for 14 hours under 80° C. temperature conditions, and was then discharged under 25° C. temperature conditions.

(Low-Temperature IV Resistance Measurement Conditions)

After the above high-temperature storage test, the battery was discharged to 1.5 V under −10° C. temperature conditions in a constant current mode and was then charged to 50% of the rated capacity. From this state, the battery was discharged at a current of 2 mA, 10 mA, 20 mA, and 50 mA for 10 seconds. The voltage measured after discharge for 10 seconds was plotted against each current, followed by determining the IV resistance from the slope obtained by linear approximation.

Results of the post-storage IV resistance of the battery of each of Examples 1 to 7 and Comparative Examples 1 to 3 were summarized in Table 1.

TABLE 1

| | | | | | | Post-storage low- |
|---|---|---|---|---|---|---|
| | Positive electrode | | | | | temperature IV |
| | First lithium transition | Second lithium transition | | Molar | Negative | resistance |
| | metal oxide | metal oxide | Additive | ratio | electrode | (Ω) |
| Example 1 | Li_{1.2}N_{i0.35}Co_{0.35}Mn_{0.3}O₂ | Li_{1.2}Ni_{0.2}Co_{0.6}Mn_{0.2}O₂ | — | 80/20/0 | Lithium-titanium | 2.37 |
| | | (0.5% of solid solution of W) | | | composite oxide | |
| Example 2 | Li_{1.2}N_{i0.35}Co_{0.35}Mn_{0.3}O₂ | Li_{1.2}Ni_{0.2}Co_{0.6}Mn_{0.2}O₂ | — | 80/20/0 | Lithium-titanium | 1.57 |
| | (0.5% of solid solution of W) | | | | composite oxide | |
| Example 3 | Li_{1.2}N_{i0.35}Co_{0.35}Mn_{0.3}O₂ | Li_{1.2}Ni_{0.2}Co_{0.6}Mn_{0.2}O₂ | WO₃ | 79.6/20/0.4 | Lithium-titanium | 1.56 |
| | (0.5% of solid solution of W) | | | | composite oxide | |
| Example 4 | Li_{1.2}N_{i0.35}Co_{0.35}Mn_{0.3}O₂ | Li_{1.2}Ni_{0.2}Co_{0.6}Mn_{0.2}O₂ | WO₃ | 89.55/10/0.45 | Lithium-titanium | 2.35 |
| | | (0.5% of solid solution of W) | | | composite oxide | |
| Example 5 | Li_{1.2}N_{i0.35}Co_{0.35}Mn_{0.3}O₂ | Li_{1.2}Ni_{0.2}Co_{0.6}Mn_{0.2}O₂ | WO₃ | 79.6/20/0.4 | Lithium-titanium | 2.14 |
| | | (0.5% of solid solution of W) | | | composite oxide | |
| Example 6 | Li_{1.2}N_{i0.35}Co_{0.35}Mn_{0.3}O₂ | Li_{1.2}Ni_{0.2}Co_{0.6}Mn_{0.2}O₂ | WO₃ | 69.65/30/0.35 | Lithium-titanium | 2.13 |
| | | (0.5% of solid solution of W) | | | composite oxide | |
| Example 7 | Li_{1.2}N_{i0.35}Co_{0.35}Mn_{0.3}O₂ | Li_{1.2}Ni_{0.2}Co_{0.6}Mn_{0.2}O₂ | WO₃ | 59.7/40/0.3 | Lithium-titanium | 2.23 |
| | | (0.5% of solid solution of W) | | | composite oxide | |
| Comparative | Li_{1.2}N_{i0.35}Co_{0.35}Mn_{0.3}O₂ | — | — | 100/0/0 | Lithium-titanium | 2.49 |
| Example 1 | | | | | composite oxide | |
| Comparative | Li_{1.2}N_{i0.35}Co_{0.35}Mn_{0.3}O₂ | Li_{1.2}Ni_{0.2}Co_{0.6}Mn_{0.2}O₂ | — | 80/20/0 | Lithium-titanium | 2.56 |
| Example 2 | | | | | composite oxide | |
| Comparative | Li_{1.2}N_{i0.35}Co_{0.35}Mn_{0.3}O₂ | — | WO₃ | 99.5/0/0.5 | Lithium-titanium | 2.63 |
| Example 3 | | | | | composite oxide | |

Comparing Comparative Examples 1 and 2 showed that the battery of Comparative Example 2 exhibited higher post-storage IV resistance. This is probably because the positive electrode contains the second lithium transition metal oxide having high Co content and therefore Co is dissolved from the positive electrode, is precipitated on the negative electrode, and promotes the increase in resistance of the negative electrode.

Comparing Example 1 and Comparative Example 2 showed that Example 1, which contained the second lithium transition metal oxide containing the W solid solution, exhibited lower post-storage IV resistance. This is probably because the positive electrode contains the second lithium transition metal oxide containing the W solid solution and therefore Co and W are dissolved from the positive electrode and are co-present on the negative electrode to increase the reactivity of the negative electrode, which contains the lithium-titanium composite oxide, thereby obtaining a specifically high negative electrode resistance increase-suppressing effect.

Comparing Example 2 and Comparative Example 2 showed that Example 2, which contained the first lithium transition metal oxide containing the W solid solution, exhibited lower post-storage IV resistance. This is probably because the positive electrode contains the first lithium transition metal oxide containing the W solid solution and therefore Co and W are dissolved from the positive electrode and are co-present on the negative electrode to increase the reactivity of the negative electrode, which contains the lithium-titanium composite oxide, thereby obtaining a specifically high negative electrode resistance increase-suppressing effect.

Comparing Examples 1 and 2 showed that Example 2 exhibited lower post-storage IV resistance. This is probably because W is more likely to be dissolved from the first lithium transition metal oxide containing the W solid solution than the second lithium transition metal oxide containing the W solid solution, thereby obtaining a specifically high negative electrode resistance increase-suppressing effect.

Comparing Examples 1 to 7 showed that Example 3 exhibited lower post-storage IV resistance as compared to Example 2 and Examples 4 to 7 exhibited lower post-storage IV resistance as compared to Example 1. This is probably because when W is present in the form of a solid solution not only in the first or second lithium transition metal oxide but also in the positive electrode, W is more likely to be dissolved from the positive electrode and a higher negative electrode resistance increase-suppressing effect is obtained.

### INDUSTRIAL APPLICABILITY

The present invention is applicable to nonaqueous electrolyte secondary batteries.

1-6. (canceled)

7. A nonaqueous electrolyte secondly battery comprising a positive electrode, a negative electrode, a separator placed between the positive electrode and the negative electrode, and a nonaqueous electrolyte,
wherein the positive electrode contains a first lithium transition metal oxide in which Ni accounts for 30 mole percent or more of the total molar amount of metal elements excluding Li; a second lithium transition metal oxide in which Co and Ni account for 60 mole percent or more and 20 mole percent or less, respectively, of the total molar amount of metal elements excluding Li: and tungsten element,
the negative electrode contains a lithium-titanium composite oxide, and
a portion of the tungsten element contained in the positive electrode is present in the form of a solid solution in at least one of the first lithium transition metal oxide and the second lithium transition metal oxide and another portion of the tungsten element contained in the positive electrode is present in the form of a tungsten compound attached to the surface of at least one of the first lithium transition metal oxide and the second lithium transition metal oxide.

8. The nonaqueous electrolyte secondary battery according to claim 7, wherein tungsten element in the tungsten compound accounts for 0.01 mole percent to 3.0 mole percent of the total molar amount of metal elements, excluding Li, in the lithium transition metal oxide.

9. The nonaqueous electrolyte secondary battery according to claim 7, wherein tungsten element present in the form of a solid solution in the lithium transition metal oxide accounts for 0.01 mole percent to 3.0 mole percent of the total molar amount of metal elements, excluding Li, in the lithium transition metal oxide.

10. The nonaqueous electrolyte secondary battery according to claim 7, wherein the tungsten compound is tungsten oxide.

11. The nonaqueous electrolyte secondary battery according to claim 10, wherein the tungsten oxide is WO₃.
